(19) United States
(12) Patent Application Publication
(10) Pub. No.: US 2011/0004539 A1
(43) Pub. Date: Jan. 6, 2011

(54) METHOD TO ENABLE SECURE ANONYMOUS OFFLINE ELECTRONIC VALUE EXCHANGE BASED ON ZERO KNOWLEDGE PROOF, BLIND SIGNATURE SCHEMES AND DOUBLE SIGNED EXCHANGE HISTORY

(76) Inventors: Jesper Rorbye Angelo, Lake Oswego, OR (US); Mikkel Porse Rasmussen, Kobenhavn (DK)

Correspondence Address: Jesper Rorbye Angelo, P.O. Box 213, Lake Oswego, OR, 97034, US

(21) Appl. No.: 12/473,272

(22) Filed: May 27, 2009

(51) Int. Cl. G06Q 40/00

(52) U.S. Cl. 705/37

(57) ABSTRACT

A transaction of an electronic valuable can be secured in an offline media by combining the known techniques of Zero-Knowledge Proofs, Blind Signing of Single-Use Tokens and using a bi-directional signing of the electronic valuable's history. The method presented here allows total anonymity for users who do not try to copy or otherwise modify the electronic valuable, while at the same time exposing misusers at the first discovery of misuse.

### BRIEF SUMMARY OF THE PROPERTIES OF INVENTION

It is an object of the present invention to provide a method for anonymous transactions of any electronic token, without the need for an immediate verification from a central authority.

It is an object of the present invention to provide this method with the ability to expose misuse of the invention, in the form of double spending.

It is an object of the present invention to provide this method with the ability to preserve anonymity for the participants of previous transactions of the token, while keeping sufficient information to expose misuse, but only in the case of misuse.

It is an object of the present invention to provide this method with the ability to prove authenticity of the token transferred using the method. [Notation used in this paper is referenced in table 1]

The present invention relates generally to the problem of transferring ownership of any electronic token of value. Several methods have been proposed over the years for dealing with electronic exchange of value tokens, mostly focused on the concept of electronic currency, but so far none of these have allowed for simultaneous anonymous and offline exchange, while at the same time maintaining the ability to track potential misuse.

Accordingly, what is desired and has not heretofore been developed is a method of transferring ownership of an electronic token of value from an authorized sender, identified by a central authority but otherwise anonymous, to a likewise authorized and anonymous receiver who is identified by the same central authority—without the need for a simultaneous or immediate verification by the central authority.

Furthermore, what is desired, and not heretofore been developed, is that the method for securing that a misuse caused by the lack of the simultaneous verification is discovered and the misuser is identified at the time of discovery of the misuse.

### DETAILED DESCRIPTION OF THE INVENTION

A electronic value transaction is defined as the transaction of a defined block of electronic data representing a real-world value, fiscal or otherwise. This includes but is not limited to electronic currency, electronic registration of deeds or car titles, access rights, electronic document ownership, decision power rights, etc.

The invention is based on secure tokens that will retain enough information about the transaction history to identify any user completing a double spending of the electronic valuable, but not enough to identify the users who only transfer the electronic valuable one time.

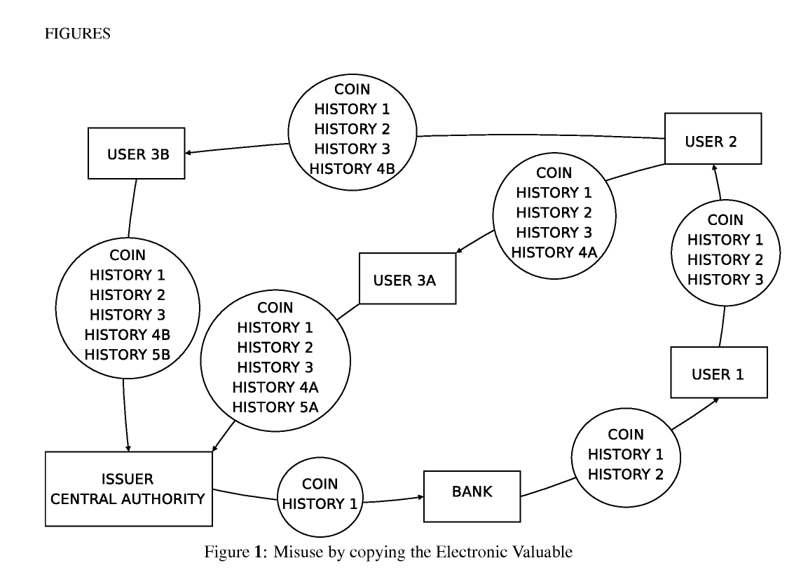

FIG. 1 illustrates the double spending principle and shows a typical path of a misused token. User 3 copies the electronic valuable and then first completes a transaction with User 4A. Following this he completes a transaction with User 4B, using the copied and electronically identical valuable. When the issuer receives two identical valuables (from User 4A and User 4B), the embedded information in the two copies of the electronic valuable allows for identification of User 3.

The identification of user 3 is accomplished by using a well-known property of Zero Knowledge Commitment Schemes, namely that the “commitment” is exposed if challenged more than once.

The presence of the identity of user 3 is ensured using a digitally signed token issued by a central trusted authority for each transaction.

Table 2 shows an example of a definition of such a token.

The transaction history is protected by bi-directional signing using a predefined and secured public-private key-pair for that transaction only.

By definition, any electronic value without a complete signing-path back to the issuer is invalid.

Table 3 shows an example of a definition of an electronic value with token and protected history.

To enable anonymity, tokens are issued using a Blind Signature Scheme. By using only one transaction token per user per transaction, the embedded information in the transaction token cannot be tied to an individual user (By the property of the Zero Knowledge Commitment Scheme), unless said user tries to use the token twice. The transaction token used is appended to the electronic valuable in a transaction history.

The core of this method is the combination of Token Based Zero-Knowledge Transactions with a Double Signed History and Blind Signature issuing of Tokens.
The Zero Knowledge scheme provides information about misusers, but can be compromised without a protected history.
The Double Signed History ensures a consistent and valid history, but does not in itself provide anonymity.
The single use of tokens issued using Blind-signing provides anonymity for the user.

### Example of a Transfer Protocol Based on Mentioned Principle

For clarification, the following example serves a possible implementation of the proposed system for an electronic coin.

The transaction protocol is divided into two phases, identification and transfer. In the identification phase, the giver and receiver verifies that both are in possession of, and using, a valid identity*. Once valid identification is done, the actual transfer is done, using the identifications just agreed upon.

### Identification Phase

P, the prover, wishes to give an electronic coin M to V, the verifier. P has already requested any number of transaction tokens from the issuer TTₚ, structured as in Table 2. V has also requested a number of transaction tokens, TTᵥ from issuer.

P chooses one of his tokens TTₚ, and sends the commit aₚ, and his public key (eₚ,Nₚ), to V. V chooses one of his tokens TT_{V}, and challenges P by sending him cᵥ. P responds to challenge by calculating z=r×w^{e}^{ₚ}. V verifies by calculating z^{e}^{ₚ}=r^{e}^{ₚ}×W^{e}^{ₚ}^{c}^{ᵥ}=a×Y^{c}^{ᵥ}. P and V exchange tokens, TTₚ and TTᵥ. V verifies TTₚ, by checking issuers signature with σₚ(TTₚ). P verifies TTᵥ, by checking issuers signature with σᵥ(TTᵥ).

Transfer phase

After both Prover and Verifier are satisfied with the identity check, Prover initiates the actual transfer of the coin to Verifier, by signing the coin and its history using his private key, dₚ, from the transaction token, thereby committing to the transaction, and sending it to Verifier.

Verifier acknowledges that its the right coin by verifying issuers signature on coin as well as Provers signature on the history, then signs the Provers signature to accept the transfer as valid.

Finally Prover signs Verifiers signature to lock the transaction.

Once the Transaction is locked, it is considered completed and the Protocol ends.

To enable anonymity, it is crucial, that any transaction token is challenged only once—ever. In this case, only Prover's token TT_{P} is challenged, and the Zero Knowledge Proof is appended to M as part of the transaction history.

What is claimed is:

1. A method for accomplishing the following within the same transaction:
An anonymous transfer of an electronic valuable between a sender and receiver, wherein both parties have certainty of anonymity.
Certainty for the receiver that the sender's anonymity will cease if the sender does not have the right to the electronic valuable because he has already transferred the ownership to a third person.
Certainty for the receiver that the electronic valuable received is an electronic valuable authorized and recognized by the central authority.
Certainty for the sender that neither receiver nor the central authority can attach verified identity to the sender or any other previous owners of the token, unless that sender or previous owner has transferred the same electronic valuable more than once.

2. The method of claim 1 for authenticity is a protection of the original electronic valuable plus any transaction tokens added later, using a traceable and protected history attached to the electronic valuable, without which the electronic valuable becomes invalidated.

3. The method of claim 1 for concealing identities is a verifiable zero-knowledge based scheme that hides enough information about the user as long as that user only uses a token exactly one time for receiving OR sending an electronic valuable.

4. The method of claim 1 for anonymity is the use of blind-signed, single use tokens created by an authorative issuer.
TABLES
TABLE 1
Data Fields used by Coin Structure Example

| Field | Parameter | Value | Size |
|---|---|---|---|
| Public Key | eₙ | Calculated by n | k bits |
| Private Key | dₙ | Calculated by n | k bits |
| Public Key Modulus | Nₙ | Calculated by n | k bits |
| ns identity | w | Implicitely define | k bits |
| Z-K “x” | Yₙ | wₙ^{e}^{ₙ} mod Nₙ | k bits |
| Z-K uniform random | rₙ | Chosen by n | k bits |
| Z-K commit | aₙ | rₙ^{e}^{ₙ} mod Nₙ | k bits |
| Z-K challenge | cₙ | Given by issuer | k bits |
| Signature by n | σₙ | Created by n | k bits |
| Signature by issuer | σᵢₛₛᵤₑᵣ | Created by issuer | k bits |
| Serial Number | Mᵥ | Created by issuer | k bits |
| Currency, | M_{c} | Created by issuer | k bits |
| Amount | M_{A} | Created by issuer | k bits |
| CreateDate | M_{B} | Created by issuer | k bits |
| ExpiryDate | M_{D} | Created by issuer | k bits |
| Issuer Coin Signature | σᵢₛₛᵤₑᵣ(M) | Created by issuer | k bits |

TABLE 2

| Transaction Token TTₙ Data Structure | |
|---|---|
| Transaction Token | TTₙ = (Yₙ, eₙ, Nₙ, aₙ, cₙ, zₙ), σᵢₛₛᵤₑᵣ(TT′ₙ) |

TABLE 3
EVE M Data Structure

| | |
|---|---|
| Basic Electronic Value | M = (Mᵥ, M_{c}, M_{A}, M_{B}, M_{D}, σissuer(M′)) |
| EV with Transaction Log | M_{TL} = (Mᵥ, M_{c}, M_{A}, M_{B}, M_{D}, |
| where | σᵢₛₛᵤₑᵣ(M′), TL₁, TL₂, . . . ) |
| | TLₙ =(H₁ = (TTₚ, TTᵥ, ZKₚ, ZKᵥ), |
| | Commit , Accept , Lock), |
| | H2 = Commit = σₚ(H₁), |
| | H3 = Accept = σᵥ(σₚ(H₁)), |
| | H4 = Lock = σₚ(σᵥ, (σₚ(H₁))) |
